(19) United States
(12) Patent Application Publication
(10) Pub. No.: US 2013/0124318 A1
(43) Pub. Date: May 16, 2013

(54) Providing Multiple Creatives For Search Queries

(71) Applicant: Sharon Sun-Young PARK, New York, NY (US)

(72) Inventor: Sharon Sun-Young PARK, New York, NY (US)

(73) Assignee: Google Inc., Mountain View, CA (US)

(21) Appl. No.: 13/293,883

(22) Filed: Nov. 10, 2011

(51) Int. Cl. G06Q 30/02

(52) U.S. Cl. 705/14.54

(57) ABSTRACT

Methods, systems, and apparatus, including computer programs encoded on a computer storage medium, for providing multiple creatives in a display order are disclosed. A user may submit a search query. Advertisements responsive to the search query are identified, and an advertisement with one or more creatives is identified based on a bid amount associated with the advertisement. One of the creatives is provided to the user based on a display order of the creative. The user may submit a second search query, and advertisements responsive to the second search query may be identified. A second creative, according to the display order, may be provided to the user from an advertisement identified based on bid amount.

### CROSS-REFERENCE TO RELATED APPLICATIONS

This application is related to U.S. patent application Ser. No. ______ [Attorney Docket Number 2525.7310000] entitled “PROVIDING MULTIPLE CREATIVES FOR CONTEXTUAL ADVERTISING,” filed ______, the content of which is incorporated herein by reference in its entirety.

### BACKGROUND

The Internet provides access to a wide range of resources. For example, web pages for particular subjects are accessible over the Internet. Access to these resources presents opportunities for advertisements to be provided with the resources. A web page can, for example, include advertisement slots for providing advertisements. These advertisements slots can be defined for presentation with a web page, for example, in a pop-up window. The advertisements slots can also be defined in the web page.

When a user performs a search using query terms or visits a web page, the query terms or the content of the web page are used to identify relevant advertisements for the slots. In a second search, the user can enter a subsequent query, or the user may visit a second web page, that identifies the same or similar relevant advertisements for the slots. The creatives for the advertisements identified for the subsequent query may be identical to the creatives for the advertisements identified for the first query.

### BRIEF SUMMARY

The embodiments described below include systems and methods for providing related advertisements in order. According to an embodiment, a method may include receiving, at a computer system, a request comprising a query from a client device. A plurality of advertisements responsive to the query may be identified at the computer system. Each advertisement may be associated with one or more creatives and a display order for each of the one or more creatives. An advertisement from the plurality of identified advertisements is selected, based on a bid amount associated with each identified advertisement. One of the creatives associated with the selected advertisement is then provided to the client device, based on the display order of the creatives.

According to another embodiment, a system can include an advertisement module, implemented on a computing device. The advertisement module may be configured to receive, at the computing device, a request comprising a query from a client device. The advertisement module may further identify a plurality of advertisements responsive to the query, where each of the advertisements is associated with one or more creatives, and a display order for each creative. The advertisement module may also select an advertisement from the plurality of identified advertisements, based on a bid amount associated with each identified advertisement. The advertisement module further provides one of the creatives of the selected advertisement to the client device, based on the display order of the creatives.

According to another embodiment, a computer readable storage medium having instructions stored thereon is provided. The instructions, when executed by one or more processors, cause the one or more processors to perform operations including receiving, at a computer system, a request comprising a query from a client device. The operations further include identifying, at the computer system, a plurality of advertisements responsive to the query. Each advertisement may be associated with one or more creatives and a display order for each of the one or more creatives. The operations may also include selecting an advertisement from the plurality of identified advertisements, based on the bid amount associated with each identified advertisement. The operations may further include providing one of the creatives associated with the selected advertisement to the client device, based on the display order of the creatives.

Further embodiments, features, and advantages, as well as the structure and operation of the various embodiments are described in detail below with reference to accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 illustrates an advertisement selection example.

FIG. 2 illustrates a further advertisement selection example.

FIG. 3 is a block diagram of an example environment in which an advertisement system manages advertising services.

FIG. 4 is a flow diagram illustrating a method for providing creatives of an advertisement based on a display order.

FIG. 5 is a flow diagram illustrating a further method for providing creatives of an advertisement based on a display order.

FIG. 6 is a swim lane diagram illustrating a process for providing creatives of an advertisement based on a display order, according to an embodiment.

FIG. 7 is a swim lane diagram illustrating a process for providing creatives of an advertisement based on a display order, according to an embodiment.

FIG. 8 is a system diagram that can be used to implement embodiments described herein.

### DETAILED DESCRIPTION

Embodiments are described herein with reference to illustrations for particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

An advertisement or an “ad” may refer to any form of communication in which one or more products, services, ideas, messages, people, organizations, or other items are identified and promoted or otherwise communicated. Ads are not limited to commercial promotions or other communications. An ad may be a public service announcement or any other type of notice, such as a broadcast or a public notice published in printed or electronic press. In some implementations, an ad may be referred to or included in sponsored content.

Ads (or promotional or digital content items generally) may be communicated via various mediums and in a number of forms. In some examples, ads may be communicated through an interactive medium, such as the Internet, and may include graphical ads (e.g., banner ads), textual ads, image ads, audio ads, video ads, ads combining one of more of the foregoing formats, or any form of electronically delivered advertisement. Ads may include embedded information, such as embedded media, links, meta-information, and/or machine executable instructions. Ads also may be communicated through RSS (Really Simple Syndication) feeds, radio channels, television channels, print media, and other media.

The term “ad” can refer to both a single “creative” and an “ad group.” A creative can refer to any entity that represents one ad impression. An ad impression can refer to any form of presentation of an ad, such that the ad is viewable or receivable by a user. In some examples, an ad impression may occur when an ad is displayed on a display device of a user access device. An ad group can refer, for example, to an entity that represents a group of creatives that share a common characteristic, such as having the same ad targeting criteria. Ad groups can be used to create an ad campaign. For convenience, advertisements and creatives are collectively referred to as “advertisements” herein.

Advertisements can be identified to be presented to a user in a number of ways. In one embodiment, a user can perform a first query and an advertisement system can use the first query to identify an advertisement responsive to the first query. The advertisement system can then, for example, provide a creative of the advertisement with search results responsive to the first query.

The user may then perform a second query. The advertisement system can use the second query to identify the same advertisement responsive to the query, and may further identify that the same user submitted both the first query and the second query. The advertisement system can then provide a second creative of the advertisement with search results responsive to the second query. The second creative provided to the user may be based on a specified display order of creatives associated with the advertisement responsive to the query.

In one embodiment, a user may visit a web page. The web page may have one or more locations on the web page where advertising is displayed. An advertisement system may use the content of the web page to identify an advertisement responsive to the content of the web page. The advertisement system can then, for example, provide a creative of the advertisement in the location on the web page.

The user may then visit a second web page. An advertisement system may use the content of the second web page to identify the same advertisement that was responsive to the first web page, and may further identify that the same user viewed the first and second web page. The advertisement system can then provide a second creative of the advertisement in a location on the second web page. The second creative provided to the user may be based on a specified display order of creatives associated with the advertisement responsive to the content of the web pages.

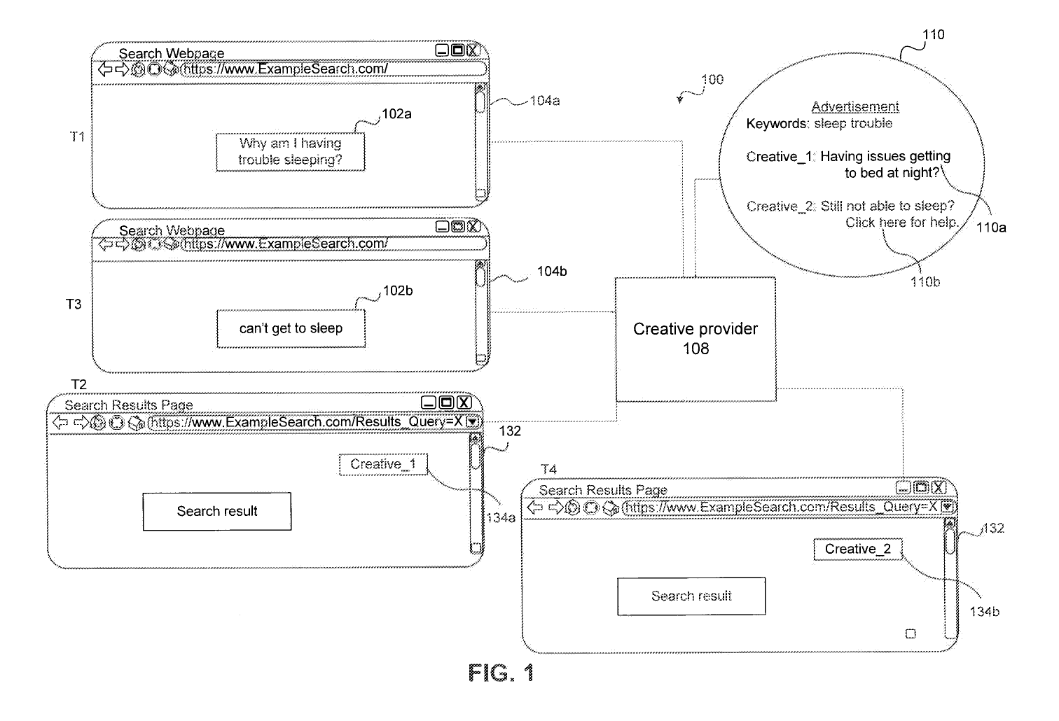

FIG. 1 illustrates an example 100 of providing multiple creatives for an advertisement.

An advertiser may provide an advertisement 110 which includes two creatives. The advertiser may choose to show Creative_{—}1 110a first, and Creative_{—}2 110b second, when the advertisement 110 is identified as responsive to a search query. Advertisement 110 is an advertisement that is associated with keywords “sleep” and “trouble”. Creative_{—}1 110a of advertisement 110 is “Having issues getting to bed at night?” Creative_{—}2 110b of advertisement 110 is “Still not able to sleep? Click here for help.” These keywords and the text of the creative are referred to as advertisement keywords. Advertisement 110 may further be associated with a bid amount.

A first query 102a is received from a browser on a client device at a time T1. The first query 102a can be received from a search engine website 104a, and may include a unique identifier for the client device or a unique identifier for the user of the client device. The creative provider 108 can identify Advertisement 110 responsive to the first query 102a. Advertisement 110 may be identified as responsive to the search query based on its associated keywords and the terms in the first query 102a. Additionally, Advertisement 110 may be identified in response to the query based on the associated bid amount. As explained above, Advertisement 110 is associated with two creatives, labeled Creative_{—}1 110a and Creative_{—}2 110b, provided by an advertiser. At time T2, the user is presented with search results pertinent to her query. Additionally, Creative_{—}1 110a of advertisement 110 is provided to the user in web page 132 at position 134a, based on the display order of the creatives. For example, because the advertiser chose to show Creative_{—}1 110a first, Creative_{—}1 110a may be provided to the user at time T2.

The user can, at a later time, submit a second query. Thus, at time T3, a second query 102b is received from a browser on the client device. The second query 102b can be received from a search engine website 104b, and may include the unique identifier for the client device or the user of the client device. In response to the second query 102b, the creative provider 108 can identify advertisement 110 responsive to the second query 102b as well. Creative provider 108 may also identify that the second query 102b was received from the same client device or same user as the first query 102a, based on the unique identifier.

At time T4 then, the user is presented with search results pertinent to second query 102b. Additionally, Creative_{—}2 110b of advertisement 110 is provided to the user in web page 132 at position 134b, based on the display order provided by the advertiser and the identification that the first query 102a and second query 102b were received from the same client device or the same user.

In this example, the user's first query 102a is “why am I having trouble sleeping?” at T1, and the user's second query 102b is “can't get to sleep” at time T2.

Advertisement 110 is further associated with a bid amount (not shown). Creatives of advertisement 110 are provided when advertisement 110 corresponds to keywords entered in a search query, and when the bid amount for advertisement 110 is greater than a bid amount for other advertisements.

The advertiser may select the display order of creatives. The advertisement system and creative provider 108 may track the creatives that have been displayed, and the creatives to be displayed, for a particular user or client device. That is, Creative_{—}1 110a of advertisement 110 may be displayed the first instance advertisement 110 is selected for display to a particular user or client device. Creative_{—}2 110b of advertisement 110 may be displayed the second instance advertisement 110 is selected for display to that particular user or client device. Each creative may also be further associated with a bid amount.

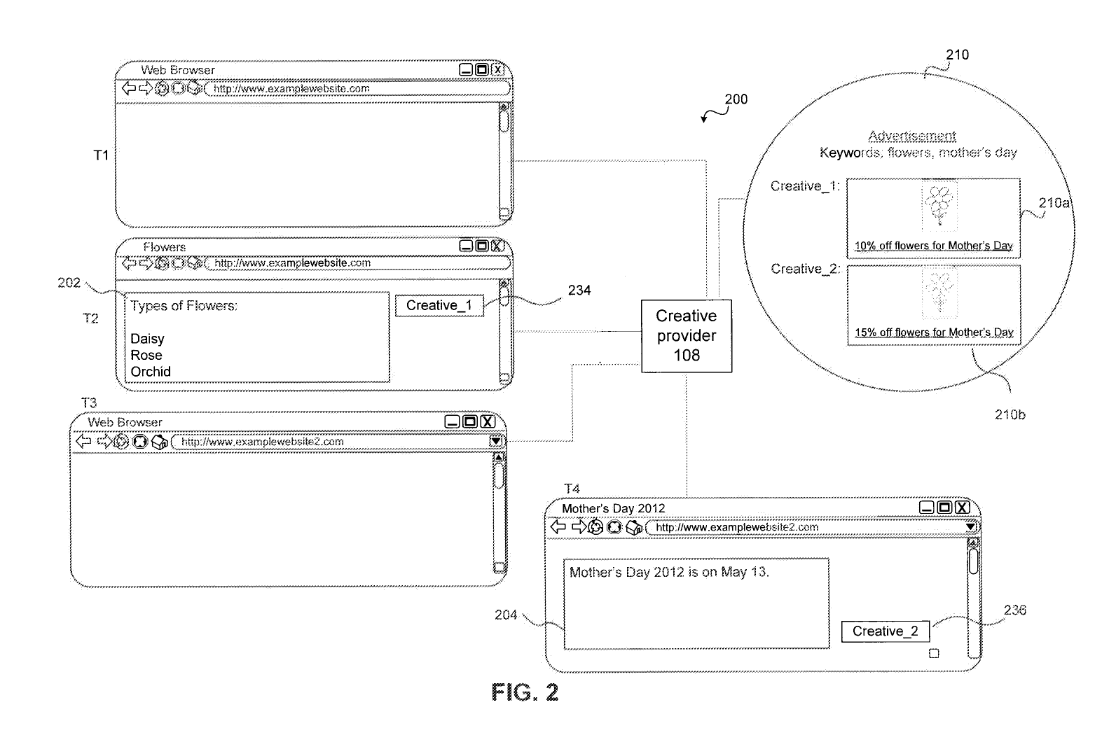

FIG. 2 illustrates a further example 200 of providing multiple creatives for an advertisement.

As in FIG. 1, an advertiser may provide an advertisement which includes two creatives. The advertiser may choose to show Creative_{—}1 210a first, and Creative_{—}2 210b second, when the advertisement 210 is identified as responsive to content or other criteria specified by the advertiser. Advertisement 210 is an advertisement that is associated with the keywords “flowers” and “mother's day”. Creative_{—}1 210a of advertisement 210 is an image with a picture of a flower accompanied by text stating “10% off flowers for Mother's Day”. Creative_{—}2 210b of advertisement 210 is an image with a picture of flowers accompanied by text reading “15% off flowers for Mother's Day”. These keywords and the text of each creative are referred to as advertisement keywords. Advertisement 210 may further be associated with a bid amount.

At a time T1, a browser on a client device may request a first web page 202, for example, by typing in a web address or Uniform Resource. Locator (URL) for web page 202 in a web browser. Web page 202, provided by a publisher, may contain content relevant to advertisement 210, and may further contain advertisement position 234. For example, web page 202 may be part of a web site providing information about common types of flowers. In response to the browser on the client device requesting web page 202, the publisher of web page 202 may transmit a request for advertisements for advertisement position 234. The request for advertisements may include a unique identifier for the client device or for the user of the client device. The creative provider 108 can identify advertisement 210 as responsive to the content of web page 202 based on its associated keywords and the content of web page 202. Additionally, advertisement 210 may be identified in response to the request based on its associated bid amount. As explained above, advertisement 210 is associated with two creatives, labeled Creative_{—}1 210a and Creative_{—}2 210b, provided by an advertiser. At time T2, the user is presented with the desired web page 202. Additionally, Creative_{—}1 210a of advertisement 210 is provided for display on web page 202 at position 234, based on the display order of the creatives. For example, because the advertiser chose to show Creative_{—}1 210a first, Creative_{—}1 210a may be provided to the user at time T2.

The user can, at a later time, visit a second web page 204. Thus, at time T3, a browser on a client device may request a second web page 204, for example, by typing in a web address or URL for web page 204. Web page 204, provided by a publisher, may also contain content relevant to advertisement 210, and may further contain an advertisement position 236. For example, web page 204 may be part of a web site providing information related to Mother's Day. In response to the browser on the client device requesting web page 204, the publisher of web page 204 may transmit a request for advertisements for advertisement position 236. The creative provider 108 can identify advertisement 210 as responsive to the content of web page 204 based on its associated keywords and the content of web page 204. Additionally, advertisement 210 may be identified in response to the request based on its associated bid amount. Creative provider 108 may also identify that the second request for advertisements was received as a result of the same client device or same user visiting a web page as the first request for advertisements, using a unique identifier for the client device or user included in the request for advertisements.

At time T4 then, the user is presented with the desired web page 204. Additionally, Creative_{—}2 210b of advertisement 210 is provided for display on web page 206 at position 236, based on the display order provided by the advertiser and the identification that the same client device or same user caused the first and second request for advertisements to be transmitted. In the example of FIG. 2, multiple creatives may allow an advertiser to tailor targeted offers to a user who has already seen one creative associated with the advertiser.

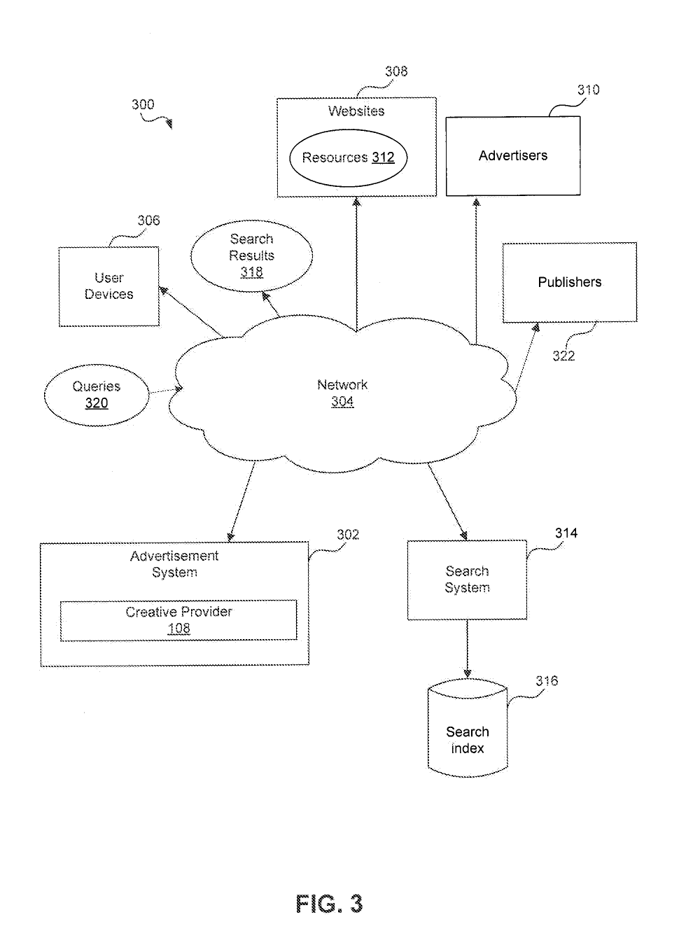

FIG. 3 is a block diagram of an example environment 300 in which an advertisement system 302 manages advertising services. The example environment 300 includes one or more networks 304, such as a local area network (LAN), a wide area network (WAN), the Internet, or a combination thereof. The network 304 connects user devices 306, websites 308, advertisers 310, and the advertisement system 302. The environment 300 may include many thousands of user devices 306, websites 308, and advertisers 310.

A website 308 is one or more resources 312 associated with a domain name and hosted by one or more servers. An example website is a collection of web pages formatted in hypertext markup language (HTML) that can contain text, images, multimedia content, and programming elements, such as scripts. Each website 308 is maintained by a publisher 322, which is an entity that controls, manages and/or owns the website 308.

A resource 312 is any data that can be provided over the network 304. A resource 312 is identified by a resource address that is associated with the resource 312. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 306 is an electronic device that is under control of a user and is capable of requesting and receiving resources over the network 304. Example user devices 306 include personal computers, mobile communication devices, and other devices that can send and receive data over the network 304. A user device 306 typically includes a user application, such as a web browser, to facilitate the sending and receiving of data over the network 304.

A user device 306 can request resources 312 from a website 308. In turn, data representing the resource 312 can be provided to the user device 306 for presentation by the user device 306. The data representing the resource 312 can also include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment can include a search system 314 that identifies the resources by crawling and indexing the resources provided by the publishers on the websites 308. Data about the resources can be indexed based on the resource to which the data corresponds. The indexed and, optionally, cached copies of the resources are stored in an indexed cache 316.

User devices 306 can submit search queries 320 to the search system 314 over the network 304. In response, the search system 314 accesses the indexed cache 316 to identify resources that are relevant to the search query 320. The search system 314 identifies the resources in the form of search results 318 and returns the search results 318 to the user devices 306 in search results pages. A search result 318 is data generated by the search system 314 that identifies a resource that is responsive to a particular search query, and includes a link to the resource. An example search result 318 can include a web page title, a snippet of text or a portion of an image extracted from the web page, and the URL of the web page. Search results pages can also include one or more advertisement slots in which advertisements can be presented.

When a resource 312 or search results 318 are requested by a user device 306, the advertisement system 302 receives a request for advertisements to be provided with the resource 312 or search results 318. The request for advertisements can include characteristics of the advertisement slots that are defined for the requested resource or search results page, and can be provided to the advertisement system 302. The request for a resource need not be limited to requests from a webpage to be displayed on a user device. Requests for resources may also originate within applications on the user device, for example, mobile user applications executing on a mobile communication device.

For example, a reference (e.g., URL) to the resource for which the advertisement slot is defined, a size of the advertisement slot, and/or media types that are available for presentation in the advertisement slot can be provided to the advertisement system 302. Similarly, keywords associated with a requested resource (“resource keywords”) or a search query 320 for which search results are requested can also be provided to the advertisement system 302 to facilitate identification of advertisements that are relevant to the resource or search query 320.

Based on data included in the request for advertisements, the advertisement system 302 can select advertisements that are eligible to be provided in response to the request (“eligible advertisements”). For example, eligible advertisements can include advertisements having characteristics matching the characteristics of advertisement slots and that are identified as relevant to specified resource keywords or search queries 320. In some implementations, advertisements having targeting keywords that match the resource keywords or the search query 300 are selected as eligible advertisements by the advertisement system 302.

The advertisement system 302 can also select advertisements to be provided based on the actions of the user controlling user device 306. For example, advertisements to be provided may be selected on the basis of whether the user has previously visited an advertiser's web site. Advertisements to be provided may further be selected on the basis of whether the user possess desired characteristics. For example, advertisements to be provided may be selected on the basis of whether the user fits a specific gender or age range. Advertisements to be provided may also be selected based on interest categories of a user. For example, if a user frequently visits web sites for auto enthusiasts, advertisements may be selected that are relevant to his interests.

A targeting keyword can match a resource keyword or a search query 320 by having the same textual content (“text”) as the resource keyword or search query 320. For example, an advertisement associated with the targeting keyword “daisy” can be an eligible advertisement for an advertisement request including the resource keyword “daisy.” Similarly, the advertisement can be selected as an eligible advertisement for an advertisement request including the search query “daisy.”

A targeting keyword can also match a resource keyword or a search query 320 by having text that is identified as being relevant to a targeting keyword or search query 320 despite having different text than the targeting keyword. For example, an advertisement having the targeting keyword “daisy” may also be selected as an eligible advertisement for an advertisement request including a resource keyword or search query for “flowers” because daisy is a type of flower, and therefore, is likely to be relevant to the term “flowers.”

The advertisement system 302 can select the eligible advertisements that are provided for presentation in advertisement slots of a resource or search results page based on results of an auction. For example, the advertisement system 302 can receive bids from advertisers and allocate the advertisement slots to the highest bidders at the conclusion of the auction. The bids are amounts that the advertisers are willing to pay for presentation (or selection) of their advertisement with a resource or search results page. For example, a bid can specify an amount that an advertiser is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a “conversion” following selection of the advertisement. The highest bidders can be determined based on the bids alone, or based on the bids of each bidder being multiplied by one or more factors, such as quality scores derived from advertisement performance, landing page scores, and the like. Quality scores may be measured in different ways, depending on the source of a request. For example, for queries, a quality score may be measured by advertisement relevance and landing page quality. For web pages provided by publishers, a quality score may be measured by a predicted performance on resources similar to those displaying the advertisement, and a performance of an advertisement group.

Advertisers can also specify budgets for their advertisement campaigns. A budget is a specified amount that an advertiser is willing to pay for distribution of content over a specified budget period. The specified period can be, for example, a specified time (e.g., one day, one week, or one year), a specified number of events (e.g., a number of impressions or clicks), or some other delineation of time or events. Once the amount the advertiser is charged for distribution of content during the budget period matches or exceeds the budget amount, the campaign can be prevented from providing content for the remainder of the budget period unless the advertiser increases or overrides its specified budget.

A conversion occurs when a user performs a particular action related to an advertisement provided with a resource or search results page. What constitutes a conversion may vary from case to case and can be determined in a variety of ways. For example, a conversion may occur when a user clicks on an advertisement, is referred to a web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, or registering on a website. Other actions that constitute a conversion can also be used.

A user can submit a first search query 320. An advertisement may be found responsive to the first search query 320. The advertisement may have multiple creatives associated with it. The multiple creatives are associated with a display order. The advertisement system 302 and creative provider 108 can provide a first creative of the advertisement to the user.

At a later time, the user can submit a second search query 320. An advertisement may be found responsive to the second search query 320. The identified advertisement may be the same as the advertisement identified for the user's first search query. Creative provider 108 and advertisement system 302 may identify that the same advertisement has been identified for the same user. Thus, the advertisement system 302 can use the multiple creatives and display order to serve a second creative of the identified advertisement in an order specified by the advertiser.

Similarly, a user can request a first resource 312. An advertisement may be found responsive to the content or keywords of resource 312. The advertisement may have multiple creatives associated with it, each associated with a display order. The advertisement system 302 and creative provider 108 can provide a first creative of the advertisement to the user.

At a later time, the user can request a second resource 312. An advertisement may be found responsive to the content or keywords of the second resource 312. The identified advertisement may be the same as the advertisement identified for the user's request of the first resource. Creative provider 108 and advertisement system 302 may identify that the same advertisement has been identified for the same user. Thus, the advertisement system 302 can use the multiple creatives and display order to serve a second creative of the identified advertisement in an order specified by the advertiser.

In these ways, advertisements with multiple creatives may be able to effectively tell a story. Further, advertisements with multiple creatives may allow an advertiser to prioritize one creative over another depending on the content of the creative. For example, an advertiser may be able to prioritize a creative that provides a larger profit margin, but also provide a second creative that may drive more traffic but is less profitable.

In embodiments, advertisement system 302 (and its creative provider 108) may be implemented in software, firmware, hardware or any combination thereof on one or more computing devices. For example, advertisement system 302 and its creative provider 108, may be part of or may be implemented with a computing device, such as, a processor-based computing device. A computing device can be any type of device having one or more processors. For example, a computing device can be a workstation, mobile device (e.g., a mobile phone, personal digital assistant, tablet or laptop), computer, server, compute cluster, server farm, game console, set-top box, kiosk, embedded system or other device having at least one processor and memory. Embodiments may be software executed by a processor, firmware, hardware or any combination thereof in a computing device.

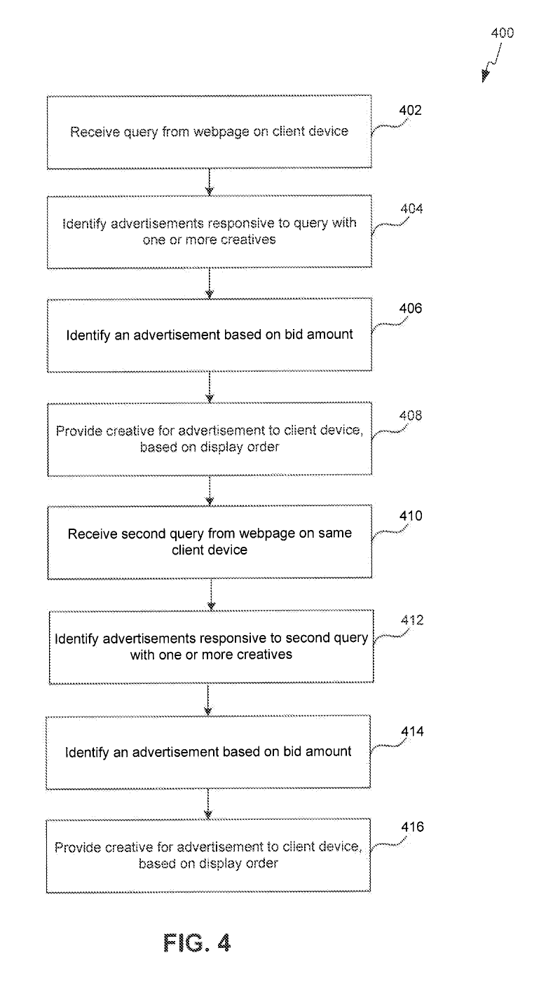

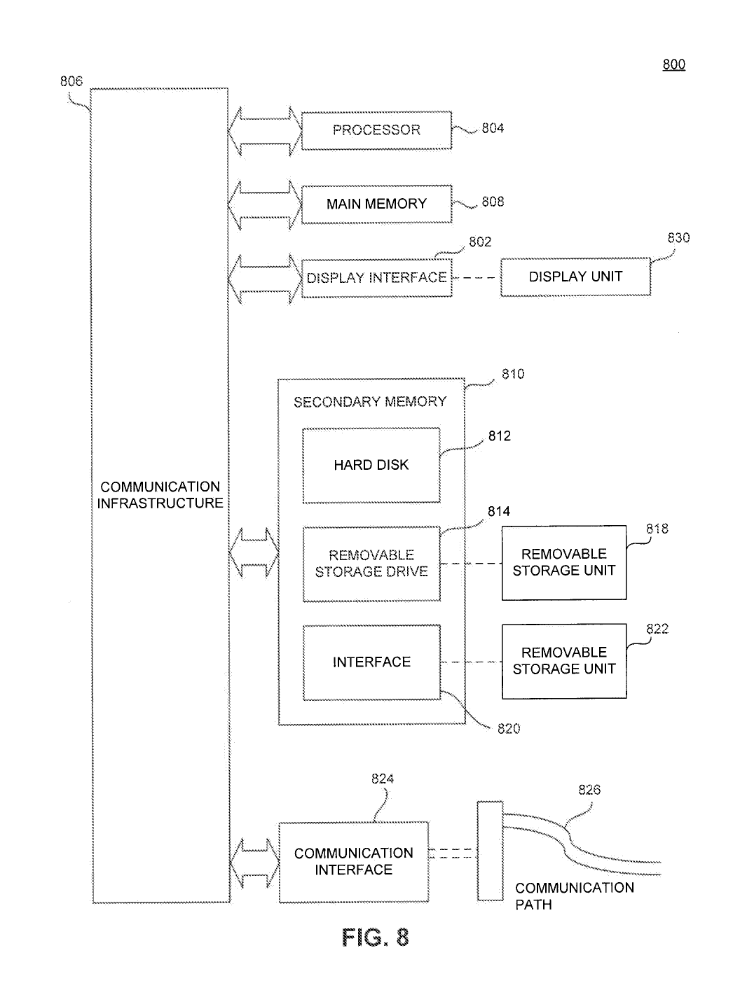

Examples of providing multiple creatives of an advertisement to a user that has submitted multiple queries or requested multiple resources are shown in FIGS. 4-7. A system that can be used to implement these examples is then described with reference to FIG. 8.

FIG. 4 illustrates an exemplary method 400 for providing multiple creatives according to display order, according to an embodiment. The process 400 can be implemented, for example, by the creative provider 108 and/or the advertisement management system of FIG. 3. In some implementations, the creative provider 108 is a data processing apparatus that includes one or more processors that are configured to perform actions of the process 400. In other implementations, a computer readable medium can include instructions that when executed by a computer cause the computer to perform actions of the process 400.

In step 402, a query is received from a web page presented on a client device. The web page may be a publisher web page, or a search engine web page. Further, the query can be a search query received from a search engine website. The query may include an identifier for the client device, such as an Internet Protocol (IP) address, a cookie, or other unique identifier for the client device. The query may also include an identifier for a user of the client device.

In step 404, advertisements responsive to the query are identified. The identified advertisements may be associated with one or more creatives. Each advertisement may also be associated with one or more keywords and a bid amount provided by the advertiser associated with the advertisement. Each advertisement may also be associated with a display order for each creative. The display order may be selected by the advertiser associated with the advertisement. Advertisements may be text-only, image-only, or a combination of both image and text.

The bid amount for the advertisement may be dependent on the current creative to be provided, based on the display order for the creative. For example, a given advertisement may have three creatives. The first creative may have a bid amount of $1.00, the second creative may have a bid amount of $0.90, and the third creative may have a bid amount of $0.75. Thus, the first time the advertisement is identified at step 404, the bid amount may be $1.00.

In step 406, a particular advertisement from the advertisements identified at step 404 is identified, based on the bid amount of the advertisement. For example, a given web page may have four display slots for advertisements. For an advertisement to be selected, it may have a bid amount associated with it that is in the top four bid amounts of all advertisements responsive to the query. For example, the bid amount of $1.00 may be in the top four bid amounts of all advertisements responsive to the query.

Based on the advertisement identified at step 406, a creative associated with the advertisement is provided to the client device at step 408. The creative provided at step 308 may be dependent on the display order for the creative. For example, if the advertisement identified at step 406 has three creatives associated with it, the creative which has been specified to be displayed first may be provided at step 408. The creative may be provided to be presented on a web page with search results responsive to the query.

At step 410, a second query from the web page from the same client device or same user is received. The client device may be identified by a unique identifier, such as an IP address or cookie, included in the query. The user may be identified by a unique identifier, such as a cookie, included in the query. The second query may have the same or similar query terms as the query received at step 402.

At step 412, advertisements responsive to the second query may be identified. Again, each advertisement may have multiple creatives, a bid amount, and a display order for each of the multiple creatives, as described with reference to step 404. The bid amount for an advertisement may be dependent on the current creative to be provided, as described above. For example, the second time an advertisement is identified, the bid amount may be that of the second creative of the advertisement. In the example given above, the bid amount may be $0.90.

At step 414, one of the advertisements identified at step 412 is identified, based on the bid amount, as described with reference to step 406. As described above, the bid amount of $0.90 may be in the top four bid amounts of all advertisements responsive to the query identified at step 412.

At step 416, if the advertisement identified at step 414 is the same as the advertisement identified at step 406, a creative associated with the advertisement is provided to the client device. The creative provided at step 416 may be dependent on the display order for the creative. For example, if the advertisement identified at step 414 and step 408 has three creatives associated with it, the creative which has been specified to be displayed second may be provided at step 416, since the creative to be displayed first was provided at step 408.

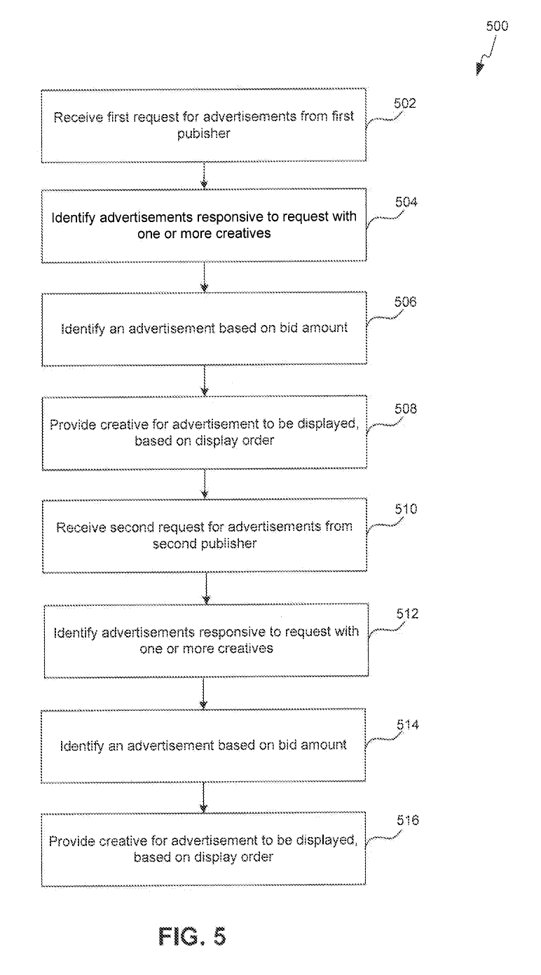

FIG. 5. illustrates an exemplary method 500 for providing multiple creatives according to display order, according to an embodiment. The process 500 can be implemented, for example, by the creative provider 108 and/or the advertisement management system of FIG. 4. In some implementations, the creative provider 108 is a data processing apparatus that includes one or more processors that are configured to perform actions of the process 500. In other implementations, a computer readable medium can include instructions that when executed by a computer cause the computer to perform actions of the process 500.

In step 502, a first request for advertisements is received from a first publisher. The first request for advertisements may be transmitted by the publisher in response to a request from a user on a client device requesting a resource, such as a web page, provided by the publisher. In one embodiment, the first-request for advertisements may be received from a mobile application executing on a mobile communications device. The request from the user may include a unique identifier for the client device or the user of the client device, which may be transmitted along with the request for advertisements.

In step 504, advertisements responsive to the request are identified. The identified advertisements may be associated with one or more creatives. Each advertisement may also be associated with one or more keywords and a bid amount provided by the advertiser associated with the advertisement. The keywords of responsive advertisements may be related to the content of the web page provided by the publisher. Further, advertisements responsive to the request may be identified based on the actions of the user or based on the particular advertisement locations, as explained above, Each advertisement may also be associated with a display order for each creative. The display order may be selected by the advertiser associated with the advertisement. Advertisements may be text-only, image-only, or a combination of both image and text.

The bid amount for the advertisement may be dependent on the current creative to be provided, based on the display order for the creative. For example, a given advertisement may have three creatives. The first creative may have a bid amount of $1.00, the second creative may have a bid amount of $0.90, and the third creative may have a bid amount of $0.75. Thus, the first time the advertisement is identified at step 504, the bid amount may be $1.00.

In step 506, a particular advertisement from the advertisements identified at step 504 is identified, based on the bid amount of the advertisement. For example, a given web page may have four display slots for advertisements. For an advertisement to be selected, it may have a bid amount associated with it that is in the top four bid amounts of all advertisements responsive to the query. For example, the bid amount of $1.00 may be in the top four bid amounts of all advertisements responsive to the query.

Based on the advertisement identified at step 506, a creative associated with the advertisement is provided to the publisher at step 508. The creative provided at step 508 may be dependent on the display order for the creative. For example, if the advertisement identified at step 506 has three creatives associated with it, the creative which has been specified to be displayed first may be provided at step 508. The creative may be provided to be presented on the web page requested by the user. In one embodiment, the creative may be provided to a publisher, who then presents it along with the web page. In one embodiment, the creative may be provided to the user, or the user's web browser, which then presents the creative along with the web page.

At step 510, a second request for advertisements is received from a second publisher. In one embodiment, the second publisher may be the same as the first publisher. In one embodiment, the second publisher may not be the same as the first publisher. The second request for advertisements may be transmitted by the publisher in response to a request from a user on a client device requesting a resource, such as a web page, provided by the second publisher. In one embodiment, the second request for advertisements may be received from a mobile application executing on a mobile communications device. The request from the user may include a unique identifier for the client device or for a user of the client device, which may be transmitted along with the second request for advertisements. The client device may be identified by a unique identifier, such as an IP address or cookie, included in the query. The user of the client device may also be identified by a unique identifier, such as a cookie, included in the query.

At step 512, advertisements responsive to the second query may be identified. Again, each advertisement may have multiple creatives, a bid amount, and a display order for each of the multiple creatives, as described with reference to step 504. The bid amount for an advertisement may be dependent on the current creative to be provided, as described above. For example, the second time an advertisement is identified, the bid amount may be that of the second creative of the advertisement. In the example given above, the bid amount may be $0.90.

At step 514, one of the advertisements identified at step 512 is identified, based on the bid amount, as described with reference to step 506. As described above, the bid amount of $0.90 may be in the top four bid amounts of all advertisements responsive to the query identified at step 512.

At step 516, if the advertisement identified at step 514 is the same as the advertisement identified at step 506, a creative associated with the advertisement is provided. In one embodiment, the creative may be provided to a publisher, who then presents it along with the web page. In one embodiment, the creative may be provided to the user, or the user's web browser, which then presents the creative along with the web page. The creative provided at step 516 may be dependent on the display order for the creative. For example, if the advertisement identified at step 514 and step 508 has three creatives associated with it, the creative which has been specified to be displayed second may be provided at step 516, since the creative to be displayed first was provided at step 508.

A creative provider 108 may identify that the same client device submitted two queries using a unique identifier included with each query submitted by the client device. For example, the unique identifier may be an IP address associated with the client device. Additionally, a client device may be identified by a cookie or other unique identifier for the client device. Each query submitted by a user using a client device may include a unique identifier for the client device.

A creative provider 108 may identify that the same user submitted two queries using a unique identifier included with each query submitted by the user. For example, a user may log in to a web site through multiple client devices, but in each case, the web site will be able to identify the user through the log-in information. Therefore, each query submitted by a user through the site may include a unique identifier for the user. The unique identifier may be presented as a cookie.

A user may limit the scope of information collected by cookies through, for example, browser options, browser plug-ins, or through user preferences with a content provider, cookie provider, a related federated user identity system, and the like. For example, users may opt out of the collection of information by cookies for a particular cookie provider or all cookie providers through browser settings. A user may also delete cookies periodically to limit the scope of information collected. Further, privacy of user information can be protected via anonymization of user data, pseudoanonymization, separation of identity data from other data, time limitations on data storage, and the like.

According to an embodiment, steps 402, 404, 406, 408, 410, 412, 414, and 416 may be performed by the creative provider 108. Further, steps 502, 504, 506, 508, 510, 512, 514, and 516 may be performed by the creative provider 108.

In the above example, the bid amount for each creative decreased based on the display order for the creative. However, the bid amount for each creative may increase instead. For example, the advertiser may set the bid amount for a first creative to be $1.00, while the second creative may have a bid amount of $1.15. Such a bidding strategy may be considered by an advertiser, since after a first creative has been provided, providing a second creative related to the first may result in a greater likelihood of a conversion.

In one embodiment, each creative may be associated with a desired maximum number of display occurrences. The maximum number of display occurrences may be selected by the advertiser associated with the advertisement. Thus, for example, the advertiser associated with advertisement 110 may specify that Creative_{—}1 110a should be displayed 3 times, and that Creative_{—}2 110b should be displayed 2 times. Accordingly, Creative_{—}1 110a may be provided the first three times advertisement 110 is selected for a user's query. Once Creative_{—}1 110a has been provided three times, Creative_{—}2 110b may then be provided. The number of times each creative is provided may also be selected by the advertiser by specifying a budget for each creative, as described further below.

In one embodiment, a user who already has viewed a particular creative associated with an advertisement may no longer be presented that creative. Thus, for example, the advertiser associated with advertisement 110 may specify that Creative_{—}1 110a should be displayed only once to a user. If advertisement 110 is selected for a user's query after Creative_{—}1 110a has been displayed to the user, Creative_{—}1 110a will not be shown on a subsequent selection of advertisement 110. In this way, multiple creatives can tell a story, and advertisers may be able to effectively storyboard an advertisement campaign.

In one embodiment, an advertiser may specify a budget for each creative associated with an advertisement. As an example, an advertiser may have a budget of $3000 for a particular campaign. The advertiser may further select how much of that budget may be allocated to each creative associated with the particular advertisement. For example, Creative_{—}1 110a of advertisement 110 may have a budget of $1000. Creative_{—}2 110b of advertisement 110 may have a budget of $2000. In such a situation, Creative_{—}1 110a may be displayed to users until the budget of $1000 is exhausted. The remaining $2000 may be used to display Creative_{—}2 110b to users until the entire budget is exhausted.

In one embodiment, creatives may be provided for presentation on search web pages, as described herein. Creatives may be presented along with search results responsive to the search query received at steps 402 and 410.

Creatives may also be provided for presentation on publisher web pages. Publishers may allow advertisements to be presented along with the content of their web pages. The content of the publisher's web page may determine what advertisements and creatives are presented.

In one embodiment, multiple video creatives associated with an advertisement may be provided to effectively storyboard the creatives. The video creatives may be provided with a desired display order as described herein. Various Internet-based video services exist which allow users to view movies, television shows, and other video content through a Web browser. An advertiser may provide multiple video creatives for an advertisement responsive to specific video content, based on keyword associated with the video content, or based on an advertiser's identification of desired video content. A first video creative of the advertisement may be shown during a first advertising portion of the video content. At a second advertising portion of the video content, the second video creative of the advertisement may be shown.

According to one embodiment, the steps of method 400 and method 500 may be combined to present multiple creatives of an advertisement according to display order, in response to both a query received from a web page presented on a client device and a request for advertisements received from a publisher. For example, an advertisement responsive to a query received from a client device may be identified in accordance with method 400. A first creative associated with the advertisement may be provided to the client device, based on the display order of the creative. At a later time, the user of the client device may request a resource, and a request for advertisements may be transmitted in accordance with method 500. A creative of an advertisement identified as responsive to the request for advertisements may be provided to the client device. If the advertisement identified as responsive to the request is the same as the advertisement identified as responsive to the query, a second creative of the advertisement may be provided to the client device, based on the display order for the creative. Similarly, a first creative of an advertisement may be provided in response to a request for advertisements from a publisher, and a second creative of the advertisement may be provided in response to a query received from a web page.

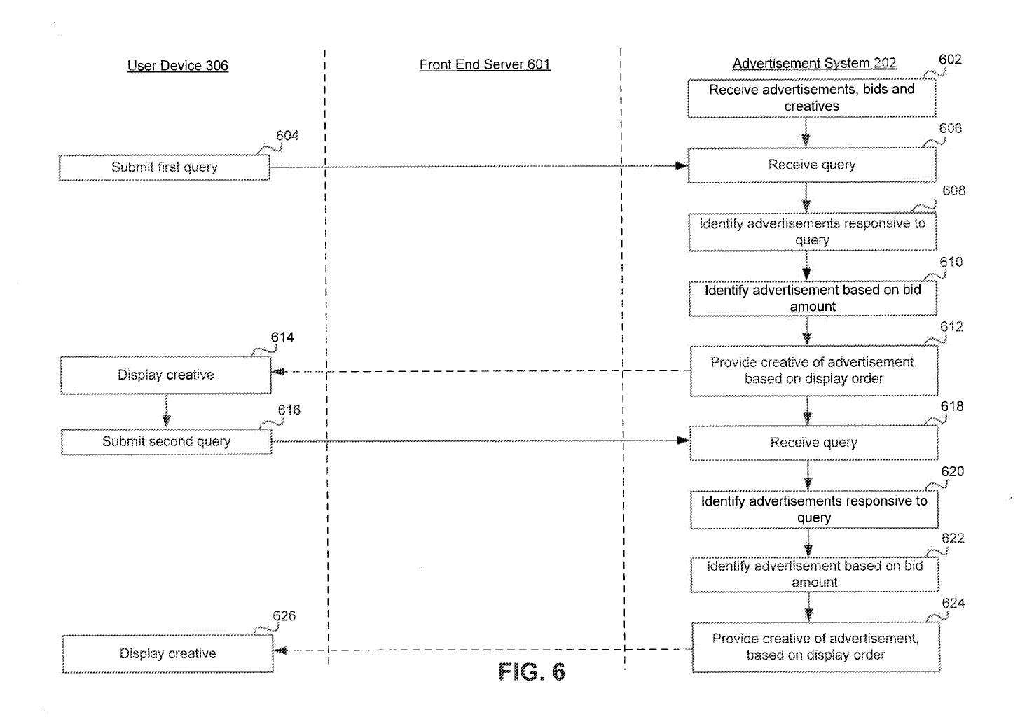

FIG. 6 is a swim lane diagram illustrating a process for presenting multiple creatives to a client device. In box 602, an advertisement system receives advertisements. Each advertisement may be associated with a bid, and one or more creatives. Each of the creatives may be associated with a display order. Further, each creative may be associated with a bid, as described herein.

In box 604, a user device 306 submits a first query. The first query may be received by advertisement system 302 in box 606. The advertisement system 302 may then identify a set of advertisements responsive to the query in box 608.

In box 610, advertisement system 302 identifies an advertisement from the set of advertisements identified in box 608, based on the bid amount of the advertisement or the bid amount of a creative of the advertisement. In box 612, advertisement system 302 provides one of the creatives of the advertisement identified in box 610, based on the display order. In box 614, the creative may be displayed by user device 306.

In box 616, user device 306 may submit a second query. The second query may be received by advertisement system 302 in box 618. The advertisement system 302 may then identify a set of advertisements responsive to the query in box 620.

In box 622, advertisement system 302 may identify an advertisement from the set based on the bid amount of the advertisement, or the bid amount of a creative of the advertisement.

In box 624, advertisement system 302 provides one of the creatives of the advertisement identified in box 624 to user device 306, based on the display order of the creative. For example, if the advertisement identified in box 622 is the same as the advertisement identified in box 610, a second creative associated with the advertisement may be provided. User device 306 may then display the creative in box 626.

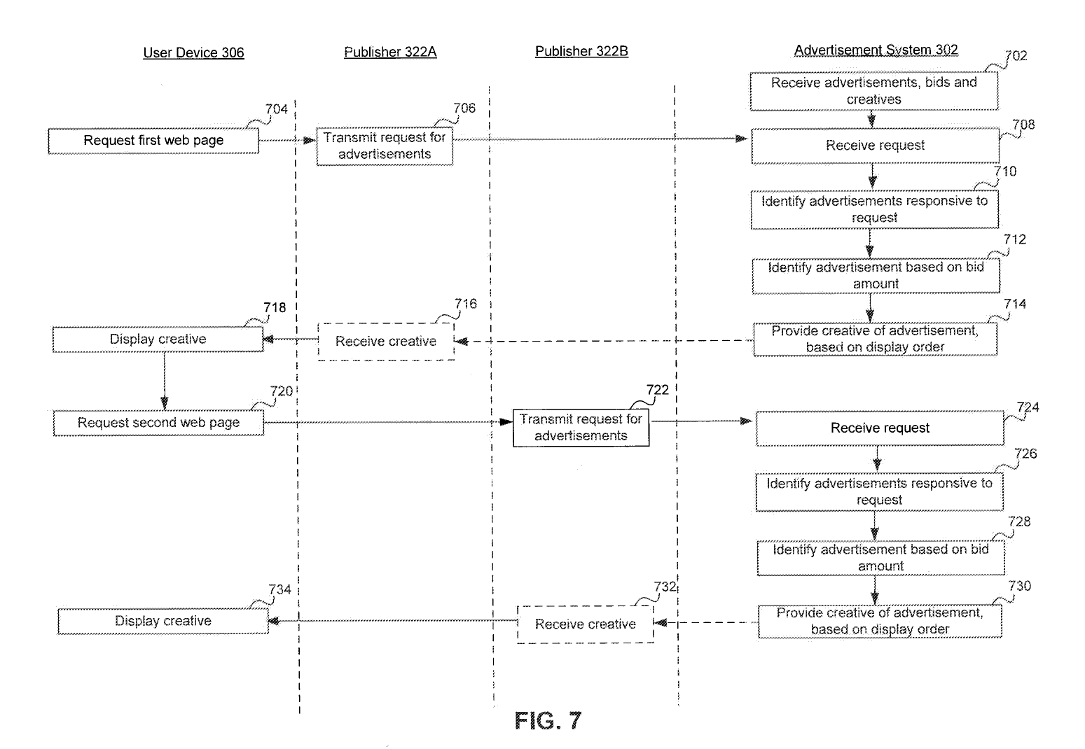

FIG. 7 is a swim lane diagram illustrating a process for presenting multiple creatives to a client device. In box 702, an advertisement system receives advertisements. Each advertisement may be associated with a bid, and one or more creatives. Each of the creatives may be associated with a display order. Further, each creative may be associated with a bid, as described herein.

In box 704, a user device 306 visits a first resource or web page associated with a first publisher 322A. In box 706, the first publisher 322 transmits a request for advertisements for the web page. The request for advertisements may be received by advertisement system 302 in box 708.

The advertisement system 302 may then identify a set of advertisements responsive to the request in box 710. In box 712, advertisement system 302 identifies an advertisement from the set of advertisements identified in box 710, based on the bid amount of the advertisement or the bid amount of a creative of the advertisement. In box 714, advertisement system 302 provides one of the creatives of the advertisement identified in box 710, based on the display order, to publisher 322. Publisher 322A may receive and display the creative of the advertisement on the web page in box 716, which in turn may be displayed by user device 306 in box 718. In one embodiment, the creative may be provided directly to user device 306 for display.

In box 720, user device 306 may visit a second resource or web page associated with a second publisher 322B. In box 722, the second publisher 322B transmits a request for advertisements for the web page. The request for advertisements may be received by advertisement system 302 in box 724.

The advertisement system 302 may then identify a set of advertisements responsive to the second request in box 726. In box 728, advertisement system 302 may identify an advertisement from the set based on the bid amount of the advertisement, or the bid amount of a creative of the advertisement.

In box 730, advertisement system 302 provides one of the creatives of the advertisement identified in box 728 to publisher 322B, based on the display order of the creative. Publisher 322B may receive and display the creative of the advertisement on the web page in box 732, which in turn may be displayed by user device 306 in box 734. In one embodiment, the creative may be provided directly to user device 306 for display. For example, if the advertisement identified in box 728 is the same as the advertisement identified in box 712, a second creative associated with the advertisement may be provided.

Aspects of the present invention shown in FIGS. 1-7, or any part(s) or function(s) thereof, may be implemented using hardware, software modules, firmware, tangible computer readable media having instructions stored thereon, or a combination thereof and may be implemented in one or more computer systems or other processing systems.

FIG. 8 illustrates an example computer system 800 in which embodiments of the present invention, or portions thereof, may by implemented as computer-readable code. For example, advertisement system 302 may be implemented in computer system 800 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-7.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 800. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general-purpose processor device. As will be appreciated by persons skilled in the relevant art, processor device 804 may also be a single processor in a multi-core/multiprocessor system, such system operating alone, or in a cluster of computing devices operating in a cluster or server farm. Processor device 804 is connected to a communication infrastructure 806, for example, a bus, message queue, network, or multi-core message-passing scheme.

Computer system 800 also includes a main memory 808, for example, random access memory (RAM), and may also include a secondary memory 810. Secondary memory 810 may include, for example, a hard disk drive 812, removable storage drive 814. Removable storage drive 814 may comprise a floppy disk drive, a magnetic tape drive, an optical disk drive, a flash memory, or the like. The removable storage drive 814 reads from and/or writes to a removable storage unit 818 in a well-known manner. Removable storage unit 818 may comprise a floppy disk, magnetic tape, optical disk, etc. which is read by and written to by removable storage drive 814. As will be appreciated by persons skilled in the relevant art, removable storage unit 818 includes a computer-readable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card, or the like. Software and data transferred via communications interface 824 may be in the form of signals, which may be electronic, electromagnetic, optical, or other signals capable of being received by communications interface 824. These signals may be provided to communications interface 824 via a communications path 826. Communications path 826 carries signals and may be implemented using wire or cable, fiber optics, a phone line, a cellular phone link, an RF link or other communications channels.

In this document, the terms “computer program medium” and “computer-readable medium” are used to generally refer to media such as removable storage unit 818, removable storage unit 822, and a hard disk installed in hard disk drive 812. Computer program medium and computer-readable medium may also refer to memories, such as main memory 808 and secondary memory 810, which may be memory semiconductors (e.g. DRAMs, etc.).

Computer programs (also called computer control logic) are stored in main memory 808 and/or secondary memory 810. Computer programs may also be received via communications interface 824. Such computer programs, when executed, enable computer system 800 to implement the present invention as discussed herein. In particular, the computer programs, when executed, enable processor device 804 to implement the processes of the present invention, such as the stages in the method illustrated by flowchart 400 of FIG. 4 or flowchart 500 of FIG. 5 discussed above. Accordingly, such computer programs represent controllers of the computer system 800. Where the invention is implemented using software, the software may be stored in a computer program product and loaded into computer system 800 using removable storage drive 814, interface 820, and hard disk drive 812, or communications interface 824.

Embodiments of the invention also may be directed to computer program products comprising software stored on any computer-readable medium. Such software, when executed in one or more data processing device, causes a data processing device(s) to operate as described herein. Embodiments of the invention employ any computer useable or readable medium. Examples of tangible computer-readable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method, comprising:
receiving, at a computer system, a request comprising a query from a client device;
identifying, at the computer system, a plurality of advertisements responsive to the query, each advertisement associated with:
one or more creatives, and
a display order for each creative;
selecting, at the computer system, an advertisement from the plurality of identified advertisements based on a bid amount associated with each identified advertisement; and
providing, at the computer system, one of the creatives associated with the selected advertisement to the client device, based on the display order of the creatives.

2. The method of claim 1, wherein the request comprises an identifier associated with the client device.

3. The method of claim 1, wherein the request comprises an identifier associated with a user of the client device.

4. The method of claim 1, wherein the display order for each creative is selected by an advertiser.

5. The method of claim 4, wherein each identified advertisement has associated with it one or more keywords selected by an advertiser.

6. The method of claim 1, wherein the query is associated with one of a publisher web page or a search engine web page.

7. The method of claim 1, wherein providing one of the creatives of the selected advertisement to the client device comprises:
providing one of the creatives associated with the selected advertisement to the client device, with search results responsive to the query.

8. The method of claim 1, wherein each creative is associated with a desired maximum number of display occurrences selected by the respective advertiser associated with the advertisement, and wherein providing one of the creatives further comprises providing one of the creatives of the advertisement to the client device, based on the display order of the creative and the desired maximum number of display occurrences.

9. The method of claim 1, wherein the request is a first request, and further comprising:
receiving a second request from the client device;
providing one of the creatives of the advertisement to the client device, based on the display order of the creative.

10. The method of claim 1, wherein each creative is associated with a bid amount selected by a respective advertiser associated with the advertisement.

11. A system, comprising:
an advertisement module, implemented on a computing device, configured to:
receive, at the computing device, a request comprising a query from a client device;
identify a plurality of advertisements responsive to the query, each advertisement associated with:
one or more creatives, and
a display order for each creative;
select an advertisement from the plurality of identified advertisements based on a bid amount associated with each identified advertisement; and
provide one of the creatives associated with the selected advertisement to the client device, based on the display order of the creatives.

12. The system of claim 11, wherein the request comprises an identifier associated with the client device.

13. The system of claim 11, wherein the request comprises an identifier associated with a user of the client device.

14. The system of claim 11, wherein the display order for each creative is selected by an advertiser.

15. The system of claim 14, wherein each identified advertisement has associated with it one or more keywords selected by an advertiser.

16. The system of claim 11, wherein the query is associated with one of a publisher web page or a search engine web page.

17. The system of claim 11, wherein the advertisement module is further configured to provide one of the creatives associated with the selected advertisement to the client device, with search results responsive to the query.

18. The system of claim 11, wherein each creative is further associated with a desired maximum number of display occurrences selected by the respective advertiser associated with the advertisement, and wherein the advertisement engine is further configured to provide one of the creatives of the advertisement to the client device based on the display order of the creative and the desired maximum number of display occurrences.

19. The system of claim 11, wherein the request is a first request, and wherein the advertisement module is further configured to:
receive a second request from the client device;
provide one of the creatives of the advertisement to the client device, based on the display order of the creative.

20. The system of claim 11, wherein each creative is associated with a bid amount selected by a respective advertiser associated with the advertisement.

21. A computer readable storage medium having instructions stored thereon that, when executed by a processor, cause the processor to perform operations including:
receiving, at a computer system, a request comprising a query from a client device;
identifying, at the computer system, a plurality of advertisements responsive to the query, each advertisement associated with:
one or more creatives, and
a display order for each creative;
selecting, at the computer system, an advertisement from the plurality of identified advertisements based on a bid amount associated with each identified advertisement; and
providing, at the computer system, one of the creatives associated with the selected advertisement to the client device, based on the display order of the creatives.

22. The computer readable storage medium of claim 21, wherein the request comprises an identifier associated with the client device.

23. The computer readable storage medium of claim 21, wherein the request comprises an identifier associated with a user of the client device.

24. The computer readable storage medium of claim 21, wherein the display order for each creative is selected by an advertiser.

25. The computer readable storage medium of claim 24, wherein each identified advertisement has associated with it one or more keywords selected by an advertiser.

26. The computer readable storage medium of claim 21, wherein query is associated with one of a publisher web page or a search engine web page.

27. The computer readable storage medium of claim 21, wherein providing one of the creatives of the selected advertisement to the client device comprises:
providing one of the creatives associated with the selected advertisement to the client device, with search results responsive to the query.

28. The computer readable storage medium of claim 21, wherein each creative is associated with a desired maximum number of display occurrences selected by the respective advertiser associated with the advertisement, and wherein providing one of the creatives further comprises providing one of the creatives of the advertisement to the client device, based on the display order of the creative and the desired maximum number of display occurrences.

29. The computer readable storage medium of claim 21, wherein the request is a first request, the operations further comprising:
receiving a second request from the client device; and
providing one of the creatives of the advertisement to the client device, based on the display order of the creative.

30. The computer readable storage medium of claim 21, wherein each creative is associated with a bid amount selected by a respective advertiser associated with the advertisement.
